(19) United States
(12) Patent Application Publication
(10) Pub. No.: US 2011/0148918 A1
(43) Pub. Date: Jun. 23, 2011

(54) INFORMATION PROCESSING APPARATUS AND CONTROL METHOD THEREFOR

(75) Inventors: Masayuki Ishizawa, Yokohama-shi (JP); Kazuhiro Watanabe, Tokyo (JP)

(73) Assignee: CANON KABUSHIKI KAISHA, Tokyo (JP)

(21) Appl. No.: 12/948,194

(22) Filed: Nov. 17, 2010

(30) Foreign Application Priority Data
Dec. 18, 2009 (JP) 2009-287819

(51) Int. Cl. G09G 5/00

(52) U.S. Cl. 345/629

(57) ABSTRACT

An information processing apparatus includes a holding unit configured to hold information that associates objects constituting images, with layers to which the objects belong, a display control unit configured to display hierarchical relationship of the layers and the objects belonging to respective layers on a display unit, based on information held in the retention unit, and a control unit configured to, when an object of interest out of displayed objects is moved by a predetermined distance or more from a layer to which the object of interest belongs, create a new layer and cause the object of interest to belong to the created layer.

### BACKGROUND OF THE INVENTION

1. Field of the Invention

The present invention relates to a technique for editing objects displayed on a screen.

2. Description of the Related Art

General editing tools for art works manage objects such as paths and rectangles by a layered structure (hierarchical structure). There are some tools that perform processing such as reshuffling of orders on a z-axis, on the objects that have overlaps on the z-axis, switching between display/non-display of objects for each layer, thereby simplifying editing of art work by managing objects by the layered structure.

In recent years, a technique associated with gesture commands that combines hand writing entry and hand writing recognition techniques has been utilized for various applications. Also, a technique for displaying gesture commands on a screen in advance, choosing the gesture command and dragging and dropping it on an operation target, thereby executing a command corresponding to chosen gesture command, on the operation target, is discussed in Japanese Patent Application Laid-Open No. 8-286831.

However, in the conventional editing tools for the art works, a user may mistakenly choose an unintended object, for example, when drag operation is performed for objects that overlap one another in the z-axis direction. Further, although it is possible to lock an editing for each layer, it is inefficient to lock and unlock the editing each time the user drags and drops an object.

### SUMMARY OF THE INVENTION

The present invention is directed to simplifying and ensuring an entry for an operation on an object displayed as an image.

According to an aspect of the present invention, an information processing apparatus includes a holding unit configured to retain information that associates objects constituting images with layers to which the objects belong, a display control unit configured to display hierarchical relationship of the layers and the objects belonging to respective layers on a display unit, based on information held in the holding unit, and a control unit configured to, if an object of interest out of displayed objects is moved by more than a predetermined distance from a layer to which the object of interest belongs, create a new layer and cause the object of interest to belong to the created layer.

According to exemplary embodiments of the present invention, each of a plurality of objects is managed by causing it to belong to any one of a plurality of hierarchical layers, and the objects are displayed for each hierarchical layer. Further, creation, deletion, or change of a hierarchical layer to which an object belongs is performed depending on a result of operation on the object. Therefore, it becomes possible to simply and surely perform an entry for an operation on an object displayed as an image.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of an information processing apparatus according to a first exemplary embodiment of the present invention.

FIGS. 2A, 2B, and 2C illustrate displays in a user interface (UI) presentation unit.

FIG. 3 is a flowchart illustrating processing when three-dimensional layered structure is displayed.

FIGS. 4A and 4B illustrate contents of layer management tables.

FIG. 5 is a flowchart illustrating processing when a layer is newly created.

FIGS. 6A, 6B, and 6C illustrate contents of editing operation on layers.

FIG. 7 illustrates a second exemplary embodiment, and illustrates an operation panel of a copy machine.

FIGS. 8A, 8B, 8C, and 8D illustrate displays in a touch screen.

FIG. 9 illustrates contents of dictionary of gesture commands.

FIGS. 10A and 10B illustrate contents of the layer management tables.

FIG. 11 is a flowchart illustrating processing when a layer with gesture command flag set true is newly created.

FIG. 12 illustrates a third exemplary embodiment and illustrates display contents.

FIGS. 13A, 13B, and 13C illustrate a fourth exemplary embodiment, and illustrate display contents.

FIGS. 14A, 14B, and 14C illustrate contents of the layer management tables.

FIGS. 15A, 15B, and 15C illustrate a fifth exemplary embodiment, and illustrate display contents.

FIG. 16 is a flowchart illustrating processing when a stroke is input.

FIGS. 17A, 17B, and 17C illustrate a sixth exemplary embodiment, and illustrate display contents.

FIGS. 18A and 18B illustrate contents of the layer management tables.

FIGS. 19A, 19B, 19C, and 19D illustrate a seventh exemplary embodiment, and illustrate display contents.

FIGS. 20A, 20B, and 20C illustrate contents of the layer management tables.

FIG. 21 illustrates an eighth exemplary embodiment, and illustrates display contents.

FIGS. 22A, 22B, 22C, and 22D illustrates a ninth exemplary embodiment, and illustrates display contents.

FIGS. 23A, 23B, 23C, and 23D illustrate a tenth exemplary embodiment, and illustrate display contents.

### DESCRIPTION OF THE EMBODIMENTS

Various exemplary embodiments, features, and aspects of the invention will be described in detail below with reference to the drawings.

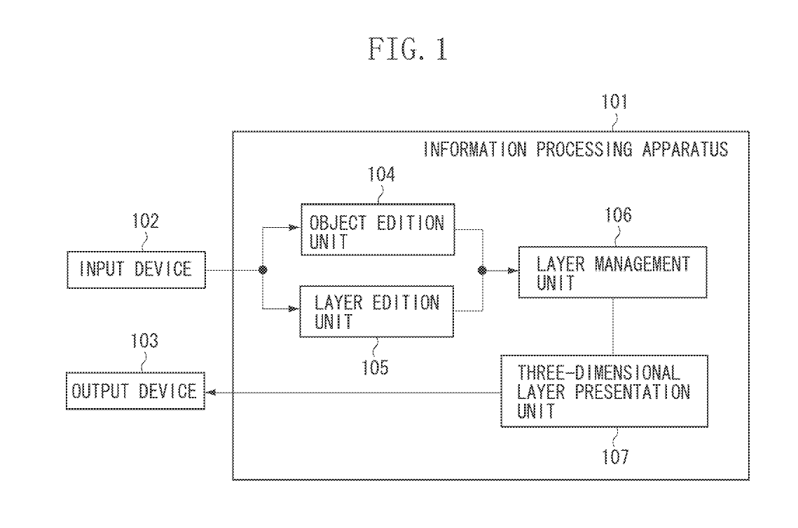

FIG. 1 is a block diagram illustrating an example of functional configuration of an information processing apparatus according to a first exemplary embodiment of the present invention. An information processing apparatus 101 can be installed into, for example, a UI presentation unit of a photo printer. In the present exemplary embodiment, as an example, a case will be described where image processing such as editing of the image and addition of information to the image is performed, by inputting a plurality of objects into an image (target objects for editing), and performing operation of movement on the input objects. Hardware of the information processing apparatus includes, for example, a central processing unit (CPU), and a read-only memory (ROM) for storing a computer program executed by the CPU, and a random-access memory (RAM) used as a work area of the CPU, a hard disk drive (HDD) for storing various types of data, and various types of interfaces. The input device 102 includes a mouse and a touch panel and the like. The output device 103 includes a display and a touch panel and the like. The object editing unit 104 controls editing for an input object. The layer editing unit 105 controls editing for layers. The layer management unit 106 manages information relating to objects and layers changed by editing in the object editing unit 104 and the layer editing unit 105. The layer management unit 106 manages layers by the layer management table. The three-dimensional layer presentation unit 107 generates information for presenting layers in three-dimensional manner.

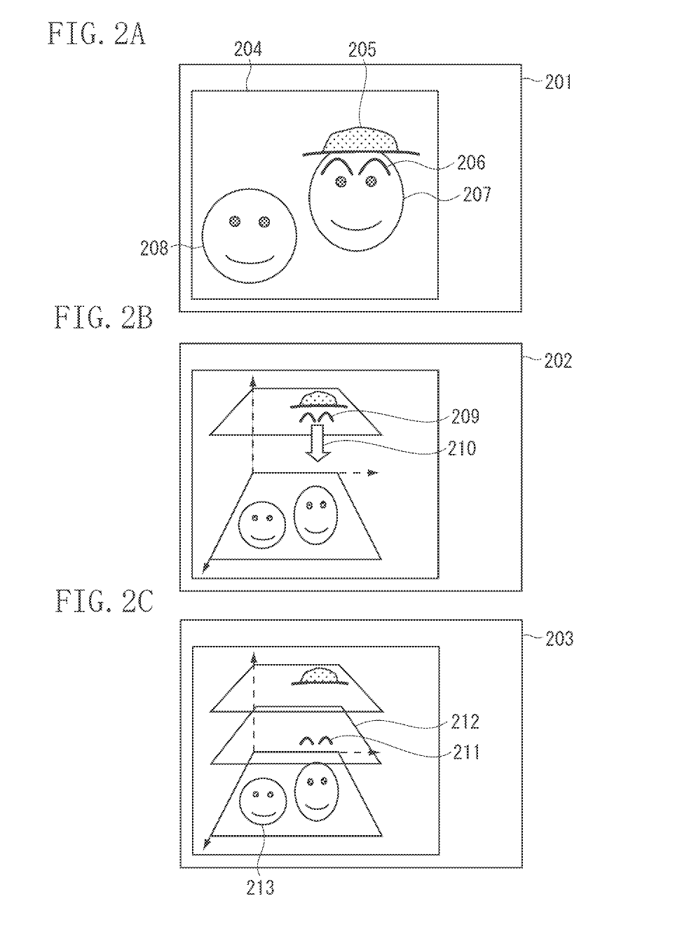

FIGS. 2A and 2B illustrate an example of displays in the UI presentation unit. FIG. 2A represents the manner how objects are input into an image 204 displayed in a screen 201 using the input device 102. A hat object 205 and an eyebrow object 206 are input in a region that overlaps a face 207 of a human A. On the other hand, no objects are input in a region that overlaps a face 208 of a human B.

In the present exemplary embodiment, a case where only the eyebrow object 206, out of objects that exist in the region that overlaps the face 207 of the human A, is caused to move to a region that overlaps the face 208 of the human B will be described in detail. FIGS. 2A and 2B illustrate an example of displays in the UI presentation unit. FIG. 2A represents the manner how objects are input into an image 204 displayed within a screen 201 using the input device 102. A hat object 205 and an eyebrow object 206 are input into a region that overlaps the face 207 of the human object “A”. On the other hand, no objects are input into in a region that overlaps the face 208 of the human object “B”. In the present exemplary embodiment, a case will be described in detail where only the eyebrow object 206, out of objects that exist in the region that overlaps the face 207 of the human object “A”, is caused to move to a region that overlaps the face 208 of the human object “B”.

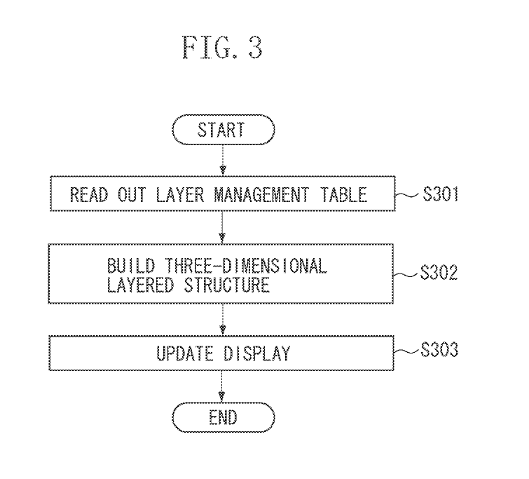

FIG. 3 is a flowchart illustrating an example of processing of the information processing apparatus 101, when display of three-dimensional layered structure is performed. More specifically, FIG. 3 is a flowchart illustrating an example of the processing for generating information for three-dimensional display in a screen 202 of FIG. 2B, from two-dimensional display in the screen 201 illustrated in FIG. 2A. An execution of the processing of FIG. 3 may be started by pressing a dedicated button which is provided in the apparatus, or may be started by inclining a device such as the information processing apparatus 101 within which a gyro sensor is provided. Alternatively, other methods may be used.

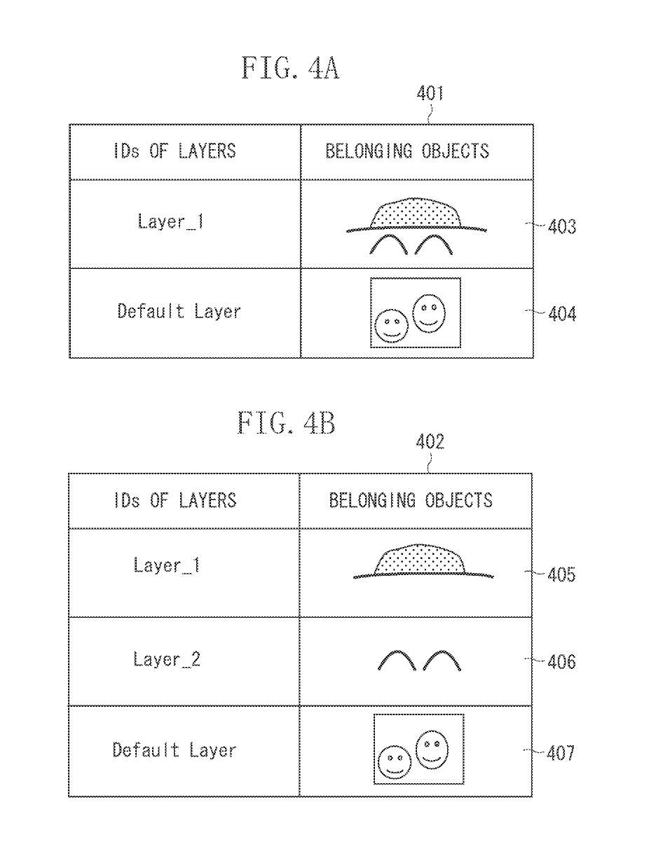

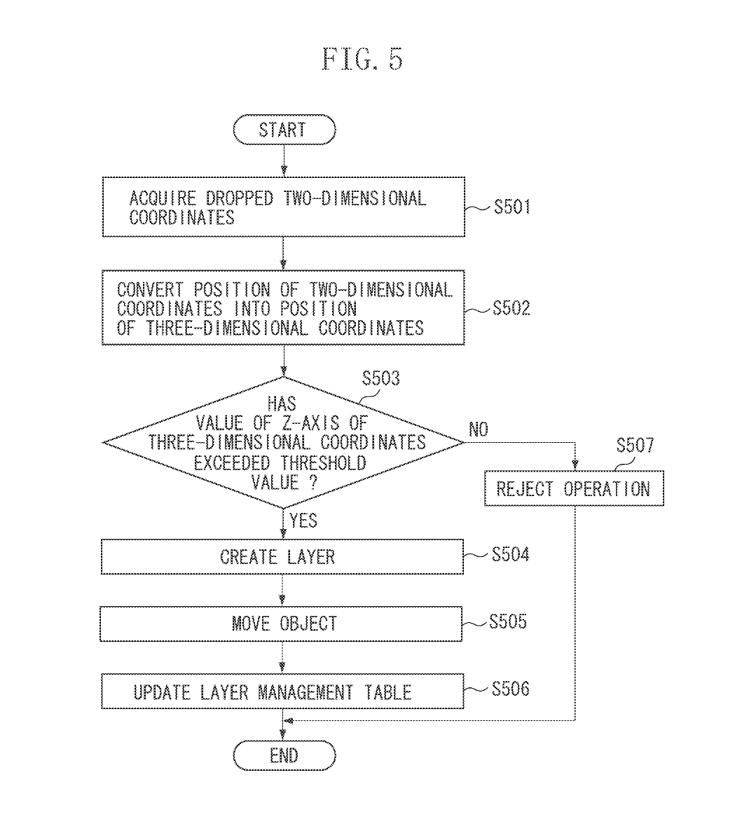

First, in step 5301, the layer management unit 106 reads out the layer management table. FIGS. 4A and 4B conceptually illustrate an example of contents of the layer management tables. The layer management table is a correspondence table in which existing layer, and contents of objects held in each layer are associated with one another. In a state where two objects 205 and 206 are input into the image 204 illustrated in FIG. 2A, a layer management table 401 illustrated in FIG. 4A is obtained. As illustrated in a region 403, the two objects 205 and 206 belong to a Layer_1. As illustrated in a region 404, the image 204 including the objects (faces of human) of the editing target belongs to a Default Layer.

Next, in step S302, the layer editing unit 105 actually creates three-dimensional layered structure (hierarchical structure), from the information of the layer management table 401 read out in step S301. More specifically, the layer editing unit 105 converts two-dimensional images into three-dimensional images by generating separately two-dimensional images corresponding to respective layers, based on the information of the objects that belong to respective layers, and performing matrix calculations. Since a method for generating the three-dimensional images from the two-dimensional images, can use a publicly known technique, detailed descriptions will not be repeated herein. The layer editing unit 105, when the three-dimensional images corresponding to respective layers are generated, arranges the Default Layer in the lowest layer on the z-axis. After that, the layer editing unit 105 arranges the layers at a certain interval from the highest layer on the z-axis in the descending order of numerical values assigned to identifications (IDs) of the layers. The layers may be arranged at an arbitrary interval.

Next, in step S303, the three-dimensional layer presentation unit 107 performs updating processing of display to present the three-dimensional layered structure created in step S302. Based on a flow as described above, information for the three-dimensional display in the screen 202 illustrated in FIG. 2B is generated from the two-dimensional display in the screen 201 illustrated in FIG. 2A, thereafter the display is updated.

FIG. 5 is a flowchart illustrating an example of processing of the information processing apparatus 101 when an editing operation is performed on objects that are present on respective layers displayed in three-dimensional manner, and the layers are newly created. In the present exemplary embodiment, a case will be described where the editing operation is drag-and-drop as an example. More specifically, FIG. 5 is a flowchart illustrating an example of the processing of newly creating a layer 212 (hierarchical layer) as illustrated in a screen 203 in FIG. 2C, by dragging and dropping an eyebrow object 209 in the screen 202 in FIG. 2B in the direction of an arrow 210. The arrow illustrated in FIG. 2B is written for convenience of explanation, which is not displayed on the screen 202. Further, in the present exemplary embodiment, an editing operation for inputting after single-clicking an object is handled as creation processing of layer. On the other hand, an editing operation for inputting without performing any operation is handled as movement processing of object. In other words, in the present exemplary embodiment, if an editing operation (drag-and-drop) is performed after single-clicking an object, the processing according to the flowchart of FIG. 5 is started.

First, in step S501, after having single-clicked, the layer editing unit 105 acquires two-dimensional coordinates on the screen 202 at the time of dropping, when the user drags and drops in a negative direction along the arrow 210 illustrated in FIG. 2B. Next, in step S502, the layer editing unit 105 converts a position of two-dimensional coordinates acquired in step S501 into a position of three-dimensional coordinates in a display represented three-dimensionally.

Next, in step S503, the layer editing unit 105 determines whether a value on the z-axis of the three-dimensional coordinates acquired in step S502 exceeds a threshold value. In other words, the layer editing unit 105 determines whether a distance between a value of the z-axis of dragged position and a value of the z-axis of dropped position exceeds the threshold value. In the present exemplary embodiment, the threshold value is to be set at an intermediate point between the Layer_1 and the Default Layer. The threshold value can be varied according to a number of layers that exist. If a value of the z-axis of the three-dimensional coordinates acquired in step S502 exceeds the threshold value, as a result of this determination (YES in step S503), then the process proceeds to step S504. If the value does not exceeds (NO in step S503), the process proceeds to step S507. When the process proceeds to step S504, the layer editing unit 105 creates the layer 212 arranged at a position of the three-dimensional coordinates acquired in step S502 (refer to FIG. 2C). The three-dimensional layer presentation unit 107 displays the layer 212 created by the layer editing unit 105, in the screen 203 illustrated in FIG. 2C, at a position of the three-dimensional coordinates acquired in step S502.

Next, in step S505, the object editing unit 104 performs processing for causing the dragged-and-dropped eyebrow object 209 to move to the layer 212 created in step S504. The three-dimensional layer presentation unit 107 changes a display position of the dragged-and-dropped eyebrow object 209, according to the processing by the object editing unit 104. The eyebrow object 209 moves to a position of the eyebrow object 211, as illustrated in FIG. 2C. Next, in step S506, the layer management unit 106 updates the layer management table, based on the processing routines in steps S501 to S505. If an ID of the layer 212 newly created by the above-described operation is a Layer_2, the layer management table 401 illustrated in FIG. 4A is changed to a layer management table 402 illustrated in FIG. 4B.

In FIGS. 4A and 4B, the Default Layers are not subjected to changes between before operation and after operation (refer to the regions 404 and 407). As for the Layer_1, before operation, the hat object and the eyebrow object belonged thereto as illustrated in the region 403. After operation, a region 405 is changed such that only the hat object belongs thereto as illustrated. Then, as illustrated in a region 406, the layer management table is changed such that the eyebrow object belongs to the newly generated Layer_2. When the change of the layer management table is finished, the processing according to the flowchart of FIG. 5 is terminated.

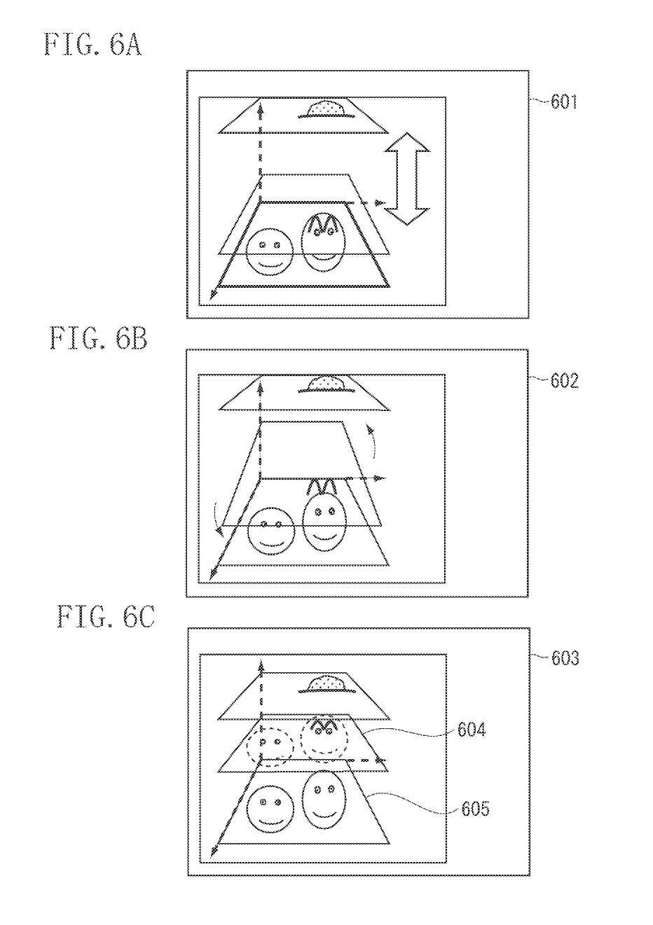

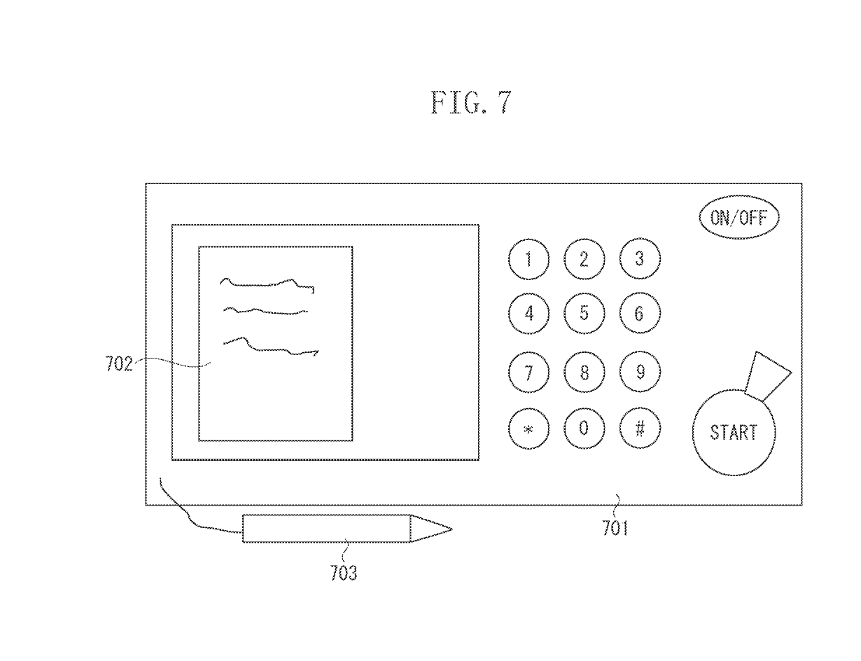

When display information of the screen 203 illustrated in FIG. 2C is generated, the user drags and drops the eyebrow object 211 on a region that overlaps a face 213 of the human B. On this occasion, the user may perform editing operation on the layers. FIGS. 6A, 6B, and 6C conceptually illustrate an example of contents of the editing operation on the layers. Input of the editing operation into the objects becomes easy by changing a distance between adjacent layers, as shown in a screen 601 of FIG. 6A, or by changing an angle which a desired layer forms with other layers, as shown in a screen 602 of FIG. 6B. The arrows in FIGS. 6A and 6B are illustrated for convenience of explanation, and are not displayed on the screens 601 and 602. Alternatively, the layer 604 maybe displayed as illustrated on a screen 603 of FIG. 6C. More specifically, first, the layer editing unit 105 identifies a layer 604 that has been subjected to drag operation for movement of the objects, as a layer of interest. Then, the three-dimensional layer presentation unit 107 displays the objects of a layer 605 of the Default Layer as a background of the objects of the layer of interest (layer 604) with semi-transparence (illustrated with dashed lines in FIG. 6C). With above operation, destination of objects can be accurately indicated.

Returning to the explanation of FIG. 5, as described above, if it is determined that a value of the z-axis of the three-dimensional coordinates acquired in step S502 does not exceed the threshold value (NO in step S503), then the process proceeds to step S507. When the process proceeds to step S507, the object editing unit 104 and the three-dimensional layer presentation unit 107 perform processing of rejecting an editing operation by the user. More specifically, the editing unit 104 and the three-dimensional layer presentation unit 107 return the eyebrow object to a position as it was before the drag operation is applied. Then, the processing according to the flowchart of FIG. 5 is terminated.

In the present exemplary embodiment as described above, respective objects to be displayed are caused to belong to any of a plurality of layers (hierarchical layers). Respective objects, which are two-dimensionally displayed, are displayed in the three-dimensional layered structure, for each layer to which the object belongs. Then, editing of target objects is performed, according to the user's instruction to the objects displayed in the three-dimensional layered structure. Since objects are three-dimensionally displayed, input of the editing operation for the objects can be performed without error, even when a plurality of objects is input close to or overlapping with one another.

Next, a second exemplary embodiment of the present invention will be described. In the first exemplary embodiment, a case has been described where an editing to move objects is performed, as an example. In contrast, in the present exemplary embodiment, a case will be described where, when a gesture command is input, an editing operation on the objects is performed based on the gesture command, as an example. Thus, the present exemplary embodiment and the above-described first exemplary embodiment are different mainly in a method for performing an editing operation on the objects. Therefore, in the descriptions of the present exemplary embodiment, the same reference numerals as the first exemplary embodiment are designated in FIG. 1 to FIGS. 6A, 6B, and 6C as to the same parts, and detailed descriptions thereof will not be repeated. The term “gesture command” refers to a publicly known technique which in a device capable of inputting loci, assigns specific locus inputs (strokes) to processing routines in advance, and when a specific locus input is performed, recognizes the locus input as editing instructions, and calls and executes the processing corresponding to the locus input. In this description, the processing is concerned with an editing an target object (image), for example, processing for changing a size or arrangement of the image.

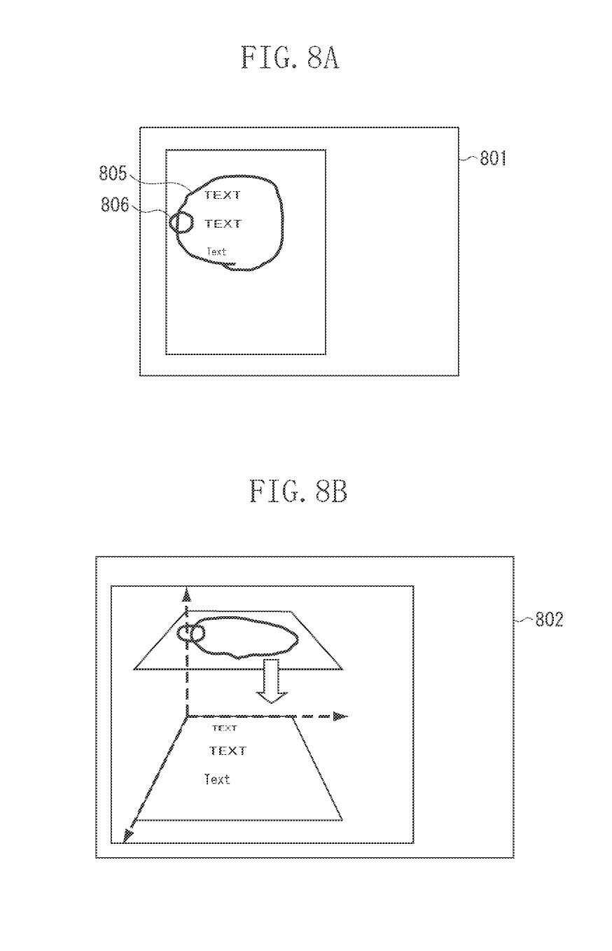

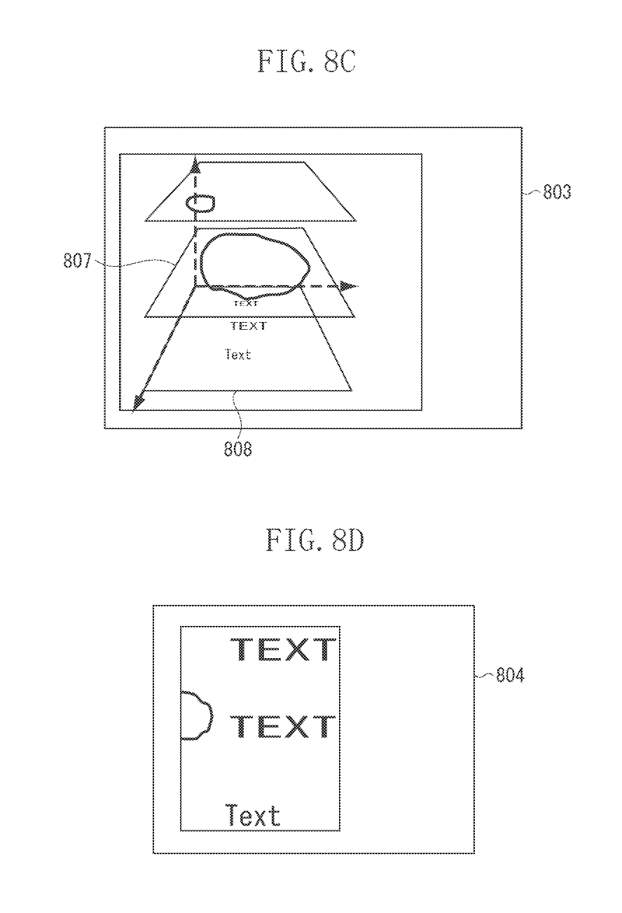

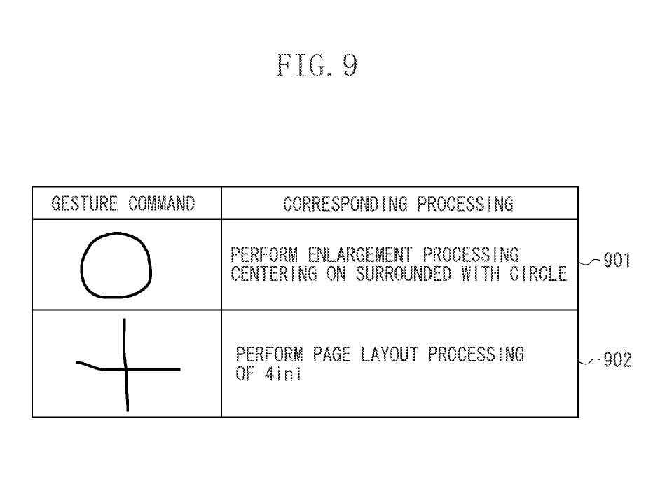

FIG. 7 illustrates an example of an operation panel of a copying machine in which an information processing apparatus is installed and is capable of entering gesture commands. In FIG. 7, a touch screen 702 is arranged in an operation panel 701, which corresponds to the input device 102 and the output device 103 illustrated in FIG. 1. The user inputs gesture commands or annotations into the touch screen 702, using a finger or a stylus pen 703. FIGS. 8A, 8B, 8C, and 8D illustrate examples of displays on a touch screen. Further, FIG. 9 illustrates conceptually an example of contents of dictionary of the gesture commands. The dictionary of the gesture commands is stored in a storage medium (e.g., a hard disk drive (HDD)) of the information processing apparatus 101. In the present exemplary embodiment, whether a drawn stroke coincides with a gesture command is to be determined only by shape without depending on stroke order.

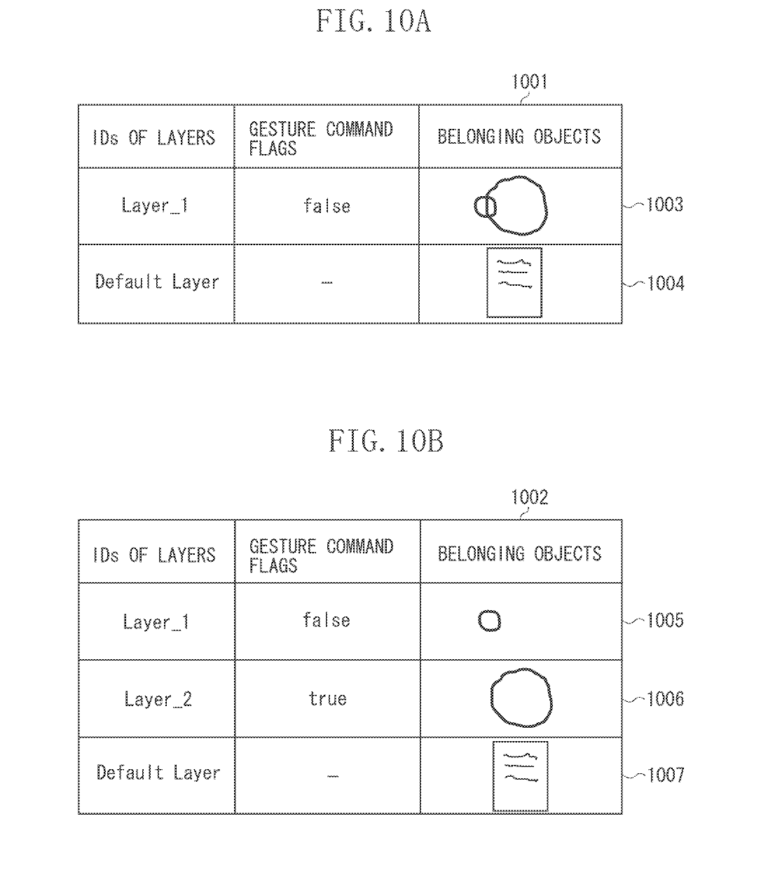

Further, FIGS. 10A and 10B illustrates conceptually an example of contents of the layer management tables. As illustrated in FIGS. 10A and 10B, an item of gesture command flag is newly provided, in addition to items indicated in the layer management tables 401 and 402 illustrated in FIGS. 4A and 4B. The gesture command flag is a flag for identifying whether an object which each layer holds is gesture command. However, regarding the Default Layer, there is no item of the gesture command flag. An object which belongs to a layer with gesture command flag set true, becomes gesture command. On the other hand, an object which belongs to a layer with gesture command flag set false, becomes annotation not gesture command.

A screen 801 illustrated in FIG. 8A, displays a state in which strokes 805 and 806 which draw two circles on the touch screen 702 are input. As illustrated in a region 901 of FIG. 9, a circular stroke corresponds to processing of enlargement centering on a portion surrounded with the circle. However, in the present exemplary embodiment, all strokes input at the time of two-dimensional display belong temporarily to a layer with gesture command flag set false as annotations, and as a result, the gesture command is not executed.

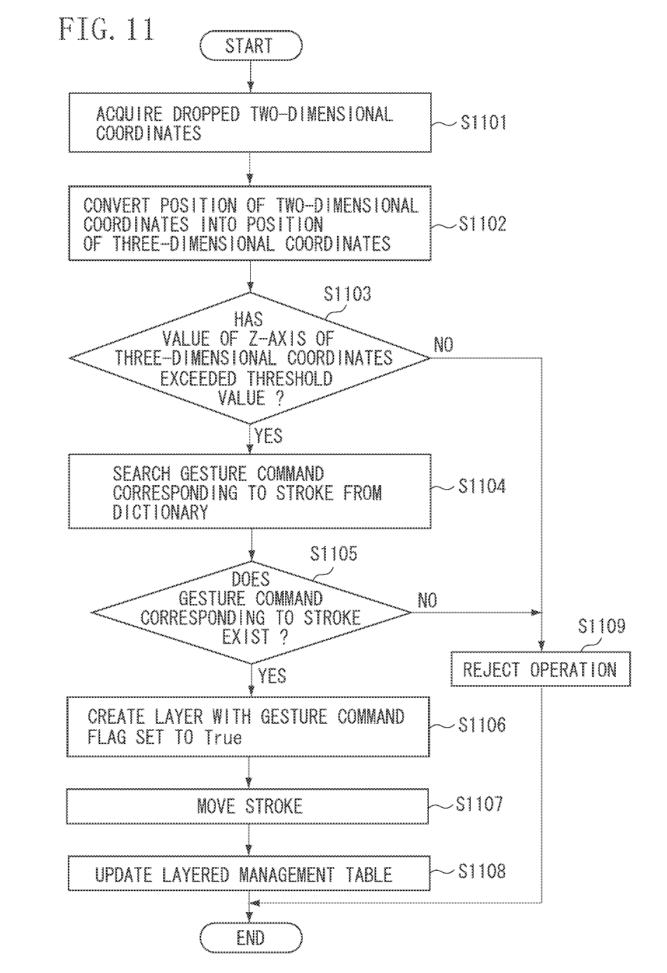

The layer management table 1001 illustrated in FIG. 10A is a layer management table in an input state like the screen 801 illustrated in FIG. 8A. As illustrated in a region 1003 of FIG. 10A, all circular strokes belong to the Layer_1 with gesture command flag set false. Processing of generating information for three-dimensional display of a screen 802 illustrated in FIG. 8B, from the two-dimensional display of the screen 801 illustrated in FIG. 8A, is executed according to the flowchart illustrated in FIG. 3, similar to the first exemplary embodiment. FIG. 11 is a flowchart illustrating an example of processing of the information processing apparatus 101, when an editing operation is performed on an object which has been three-dimensionally displayed, and a layer with gesture command flag set true is newly created. Also in the present exemplary embodiment, similar to the first exemplary embodiment, a case will be described where the editing operation is drag-and-drop, as an example. Further, the editing operation of inputting after single-clicking the object is creation processing of the layer, whereas the editing operation of inputting without performing any operation is movement processing of the object.

First, in step S1101, the layer editing unit 105, similar to the processing in step S501, acquires two-dimensional coordinates on the touch screen 702 at the time of drop operation, when the user drags and drops the object in a negative direction of the z-axis (refer to the arrow within the screen 802 of FIG. 8B). The arrow illustrated in FIG. 8B is written for convenience of explanation, and is not displayed on the screen 802. Next, in step S1102, the layer editing unit 105, similar to the processing in step S502, converts a position of the two-dimensional coordinates on the touch screen 702 acquired in step S1101 to a position of the three-dimensional coordinates in a three-dimensionally represented display. Next, in step S1103, the layer editing unit 105, similar to the processing in step S503, determines whether a value of the z-axis of the three-dimensional coordinates acquired in step S1102 exceeds the threshold value. If a value of the z-axis of the three-dimensional coordinates acquired in step S1102 exceeds the threshold value (YES in step S1103), as a result of this determination, then the process proceeds to step S1104. If the value does not exceeds the threshold value (NO in step S1103), then the process proceeds to step S1109.

When the process proceeds to step S1104, the layer editing unit 105 searches a gesture command corresponding to a stroke input into the touch screen 702 from dictionary of gesture commands (refer to FIG. 9). Next, in step S1105, the layer editing unit 105 determines whether a gesture command corresponding to a stroke input into the touch screen 702 exists in the dictionary of the gesture commands. If a gesture command corresponding to a stroke exists in the dictionary of the gesture commands (YES in step S1105), as a result of this determination, then the process proceeds to step S1106. If the gesture command does not exists (NO in step S1105), then the process proceeds to step S1109. When the process proceeds to step S1106, the layer editing unit 105 creates a “layer with gesture command flag true” arranged at a position of the three-dimensional coordinates acquired in step S1102 (refer to a layer 807 in a screen 803 of FIG. 8C). The three-dimensional layer presentation unit 107 displays a layer created by the layer editing unit 105, in the touch screen 702, at a position of the three-dimensional coordinates acquired in step S1102. Next, in step S1107, the object editing unit 104 performs processing for moving a dragged-and-dropped stroke to the layer created in step S1106. The three-dimensional layer presentation unit 107 changes display position of the dragged-and-dropped stroke, according to the processing by the object editing unit 104 (refer to circular stroke displayed on the layer 807 in the screen 803 of FIG. 8C).

Next, in step S1108, the layer management unit 106 updates the layer management table, based on the processing in steps S1101 to S1107. If an ID of the layer newly created by the above-described operation is the Layer_2, a layer management table 1001 illustrated in FIG. 10A is changed to a layer management table 1002 illustrated in FIG. 10B. In FIGS. 10A and 10B, regarding the Default Layer, similar to the first exemplary embodiment, no change takes place between before operation and after operation (refer to regions 1004 and 1007). Regarding the Layer_1, before operation, objects of two circular strokes belong thereto as illustrated in the region 1003. After operation, however, the layer management table is changed such that only an object of one circular stroke belongs thereto as illustrated in a region 1005. Then, the layer management table is changed such that an object of another circular stroke belongs to a newly created Layer_2, as illustrated in a region 1006, and moreover, “true” is set as a gesture command flag of this layer. When such a change of the layer management table is finished, the processing according to the flowchart of FIG. 11 is terminated.

In the present exemplary embodiment, when the processing illustrated in FIG. 11 is executed, and a layer with command flag set true is created, a gesture command corresponding to an input stroke is immediately executed. However, an execution of the gesture command is not limited to the one started in this manner. For example, the gesture command may be executed by pressing the button separately provided. Alternatively, the gesture command may be executed by dragging and dropping “a layer 807 with command flag set true” on a Default Layer 808 in FIG. 8C. Alternatively, the gesture command may be executed by other methods.

A screen 804 illustrated in FIG. 8D indicates a state where an execution result of the gesture command is displayed on the touch screen 702, after executing the gesture command, and returning three-dimensional display to two-dimensional display. In FIG. 8D, since an object of the circular stroke 805 illustrated in FIG. 8A has been executed as a gesture command, the object is invisible. On the other hand, since an object of the circular stroke 806 exists as an annotation, the object is displayed after being subjected to enlargement processing similar to a text document displayed in the Default Layer 808. Returning to explanation of FIG. 11, when the process proceeds from step S1103 or step S1105 to step S1109, the object editing unit 104 and the three-dimensional layer presentation unit 107 reject the editing operation by the user. More specifically, the object editing unit 104 and the three-dimensional layer presentation unit 107 return the stroke to a location where it was before applying drag operation. Then, the processing according to the flowchart of FIG. 11 is terminated.

In the present exemplary embodiment as described above, when respective two-dimensionally displayed strokes are sorted for each layer to which the stroke belongs, and are displayed in the three-dimensional layered structure, a stroke which was subjected to editing operation is displayed on a layer to indicate that the stroke is a gesture command. On the other hand, a stroke which was not subjected to the editing operation is displayed on a layer to indicate that the stroke is not a gesture command (annotation). Then, the stroke which was subjected to the editing operation is taken as a gesture command, and the processing corresponding to the gesture command is executed. In this case, a stroke that was not subjected to the editing operation is displayed as an annotation. In this manner, by managing annotations and gesture commands by sorting them into different layer, the effect in which the annotation and the gesture command can be distinguished clearly is obtained, in addition to the effect described in the first exemplary embodiment.

Next, a third exemplary embodiment of the present invention will be described. In the above-described second exemplary embodiment, as an example, a case will be described where gesture commands are executed individually as an example. In contrast, in the present exemplary embodiment, as example, a case will be described where additional information is given to a gesture command, taking also contents of the additional information into account, and thus the gesture command is executed, as an example. Thus, the present exemplary embodiment is an embodiment in which processing based on the additional information is added to the above-described second exemplary embodiment. Therefore, in the descriptions of the present exemplary embodiment, the identical reference numerals to the reference numerals designated in FIG. 1 to FIG. 11 are designated to the parts identical to those in the above-described first and second exemplary embodiments, and thus detailed descriptions thereof will not be repeated. In the present exemplary embodiment, an execution of gesture commands is to be performed, when a predetermined button is pressed, or a layer with gesture command flag set true is dragged and dropped on the Default Layer.

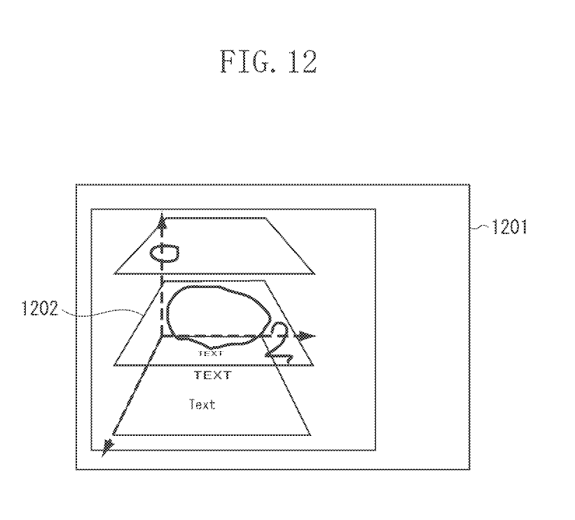

Also, in the present exemplary embodiment, similar to the second exemplary embodiment, the processing according to the flowchart illustrated in FIG. 11 is performed. In the present exemplary embodiment, the processing described below will be added during a period after the processing according to the flowchart illustrated in FIG. 11 is terminated, until the gesture command is executed. As of the moment when the processing according to the flowchart illustrated in FIG. 11 is terminated, the touch screen 702 displays a screen like the screen 803 illustrated in FIG. 8C. In this process, in the present exemplary embodiment, when drag operation is input into three-dimensionally displayed layer like the screen 803, without performing any operation, movement processing of the layer is performed, and when drag operation is performed after single-clicking, a stroke can be input into the layer of the operation target. FIG. 12 illustrates an example of display in the touch screen, and illustrates an example of the manner how a stroke is input into a layer of which gesture command flag is true. As illustrated in a screen 1201 of FIG. 12, when a stroke representing a numerical value (2 in FIG. 12) is input into a layer 1202 of which gesture command flag is true, the layer editing unit 105 recognizes the input as a setting of property of the gesture command.

For this reason, in the present exemplary embodiment, each gesture command has an attribute set as its property. When the gesture command dictionary illustrated in FIG. 9 is taken as an example, an enlargement ratio is set as its property for a gesture command illustrated in the region 901. In other words, when “2” is input, processing of enlarging an object at an enlargement ratio of twice will be executed. On the other hand, a number of layouts per page is set as its property, in a gesture command illustrated in a region 902. In other words, when “2” is input, the processing for performing page layout at 2 in 1 rather than at 4 in 1 will be executed.

In the example illustrated in FIG. 12, “2” is input into “the layer 1202 of which a gesture command flag is true” into which a circular stroke has been input. Therefore, information of an enlargement factor of 2 will be added to the gesture command, and processing for enlarging the circular stroke centering on a circle at an enlargement factor of 2 is executed.

In the present exemplary embodiment as described above, when additional information indicating execution contents of processing according to the gesture command is input into a layer of which the gesture command flag is true, the gesture command is executed according to the additional information. Therefore, the following effect is obtained, in addition to the effect described in the above-described exemplary embodiments. In the conventional gesture command, if the processing is performed with different magnification ratios, respective processing need to be registered as different processing on the dictionary. In contrast, as shown in the present exemplary embodiment, amount of information to be registered as contents of the processing corresponding to the gesture command can be reduced, by inputting additional information indicating execution contents of the processing according to the gesture command, as a property of the gesture command.

Next, a fourth exemplary embodiment of the present invention will be described. In the above-described second and third exemplary embodiments, as an example, a case has been described where only one layer with gesture command flag set true is created as an example. In contrast, in the present exemplary embodiment, a case will be described where plural numbers of at least either layer with gesture command flag set true or false, are created in as an example. Thus, between the present exemplary embodiment, and the second and third exemplary embodiments, the processing is different mainly depending on difference in a number of the layers with gesture command flags set true or false. Therefore, in the descriptions of the present exemplary embodiment, reference numerals designated to FIG. 1 to FIG. 12 are designated to the parts identical to the above-described first to third exemplary embodiments, and thus detailed descriptions thereof will not be repeated. Also in the present exemplary embodiment, execution of the gesture command is to be performed, similar to the third exemplary embodiment, when a predetermined button is pressed, or a layer with gesture command flag set true is dragged and dropped on the Default Layer.

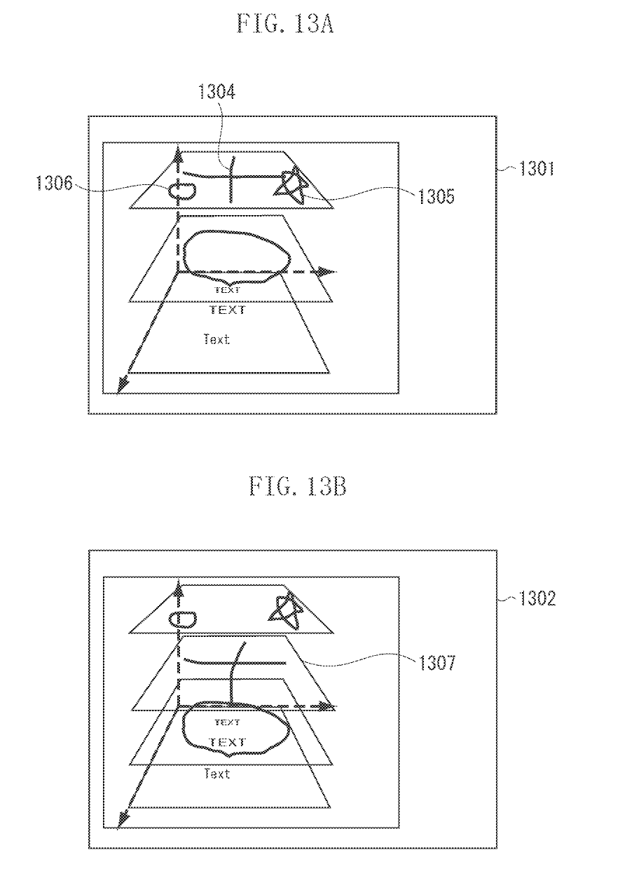

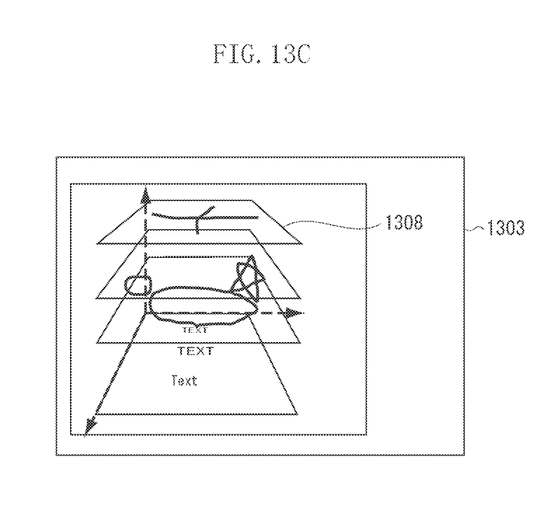

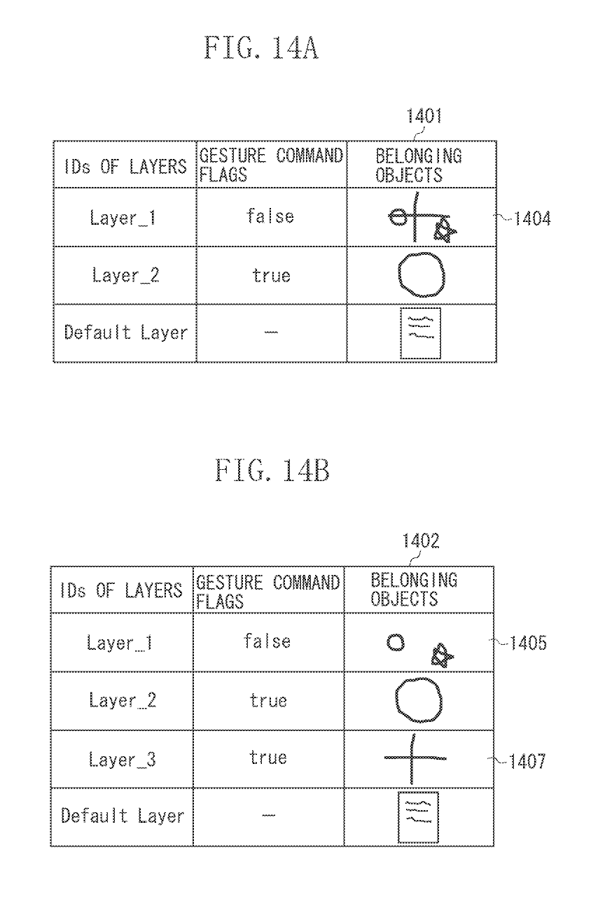

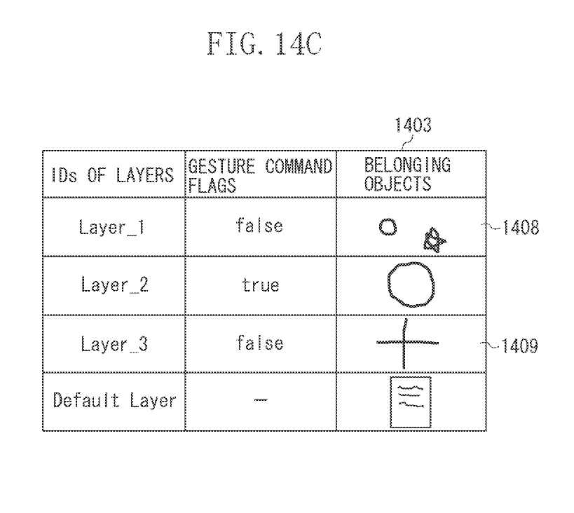

FIGS. 13A, 13B, and 13C illustrate an example of a state where a star type object 1305, and a cross object 1304 are input into a layer with gesture command flag set false, in the screen 803 illustrated in FIG. 8C. Further, FIGS. 14A, 14B, and 14C conceptually illustrate an example of contents of the layer management tables. A layer management table 1401 illustrated in FIG. 14A indicates a layer management table in a state illustrated in FIG. 13A. As illustrated in a region 1404, newly input objects belong to the Layer_1 with gesture command flag set false. Drag-and-drop operation in a negative direction of the z-axis is performed on the cross object 1304, and similar to the second and third exemplary embodiments, creation processing of a layer with gesture command flag set true is performed (refer to FIG. 11). Then, a layer with gesture command flag set true is newly created. A screen 1302 illustrated in FIG. 13B, illustrates an example of a state where a layer with gesture command flag set true is newly created. On the screen 1302, a layer 1307 with gesture command flag set true is added, relative to a screen 1301 illustrated in FIG. 13A. A layer management table 1402 illustrated in FIG. 14B indicates a layer management table in a state illustrated in FIG. 13B. The cross object moves from the Layer_1 with gesture command flag set false to the Layer_3 with gesture command flag set true (refer to regions 1404, 1405, and 1407).

If there exists a plurality of layers of which gesture command flags are true, the appearance such as frame of layer or color of stroke may be changed, depending on difference in states such as after execution, or before execution of the gesture command, for each of the layers. In this way, the difference can be presented to the user. Further, the appearance such as frame of layer or color of stroke may be changed, depending on whether a gesture command flag of a layer is true or false. These can be also applied to the second and third exemplary embodiments. Further, a plurality of gesture commands may be executed in sequence according to display order of the layers, by replacing display orders of the layers on the z-axis. This can be also applied to the first to third exemplary embodiments.

Heretobefore, there has been described only a case where when upon dragging and dropping the object in a negative direction of the z-axis (in a downward direction of FIG. 13A), in a state as illustrated in FIG. 13A, if dropped position exceeds the threshold value, a layer with gesture command flag set true is newly created. In the present exemplary embodiment, in a similar manner, upon dragging and dropping the object in a positive direction (in an upward direction of FIG. 13A) of the z-axis direction, if dropped position exceeds the threshold value, a layer with gesture command flag set false is to be newly created. When drag-and-drop operation is performed in the positive direction of the z-axis on the cross object 1304 illustrated in FIG. 13A, creation processing of a layer with gesture command flag set false is performed, and a layer with gesture command flag set false is newly created. A screen 1303 illustrated in FIG. 13C indicates an example of a state where a layer with gesture command flag set false is newly created. On the screen 1303, a layer 1308 with gesture command flag set to false is added to the screen 1301 illustrated in FIG. 13A. The layer management table 1403 illustrated in FIG. 14C indicates a layer management table in a state illustrated in FIG. 13C. The cross object moves from the Layer_1 with gesture command flag set false, to the Layer_3 with gesture command flag set false (refer to regions 1404, 1408, and 1409). When layer creation processing as described above is implemented, it is conceivable that the layers cannot fit in a display region. In such a case, a size of the display region may be automatically changed, or a slide bar may be automatically displayed.

In the present exemplary embodiment as described above, it is designed to create and display a plural numbers of at least either of a layer with gesture command flag set true, or a layer with gesture command flag set false. Therefore, in addition to the effect described in the above-described exemplary embodiments, the effect in which a plurality of annotations and a plurality of gesture commands can be distinguished clearly therebetween and handled is obtained.

Next, a fifth exemplary embodiment of the present invention will be described. In the above-described second to fourth exemplary embodiments, as an example, a case has been described where, after a stroke has been input, once the stroke belongs to a layer for annotation (a layer with gesture command flag set false), and a gesture command corresponding to the stroke is not immediately executed, as an example. In contrast, in the present exemplary embodiment, a case where the gesture command is immediately executed will be described. Thus, a portion of the processing of executing the gesture command corresponding to the input stroke is mainly different between the present exemplary embodiment and the above-described second to fourth exemplary embodiments. Therefore, in the descriptions of the present exemplary embodiment, the identical reference numerals to reference numerals designated to FIG. 1 to FIGS. 14A, 14B, and 14C are designated to the parts identical to those in the above-described second to fourth exemplary embodiments, and the detailed descriptions thereof will not be repeated. In the present exemplary embodiment, as an example, a case will be described where surrounding a face of human object with a circular stroke corresponds to a gesture command for deforming a face slim.

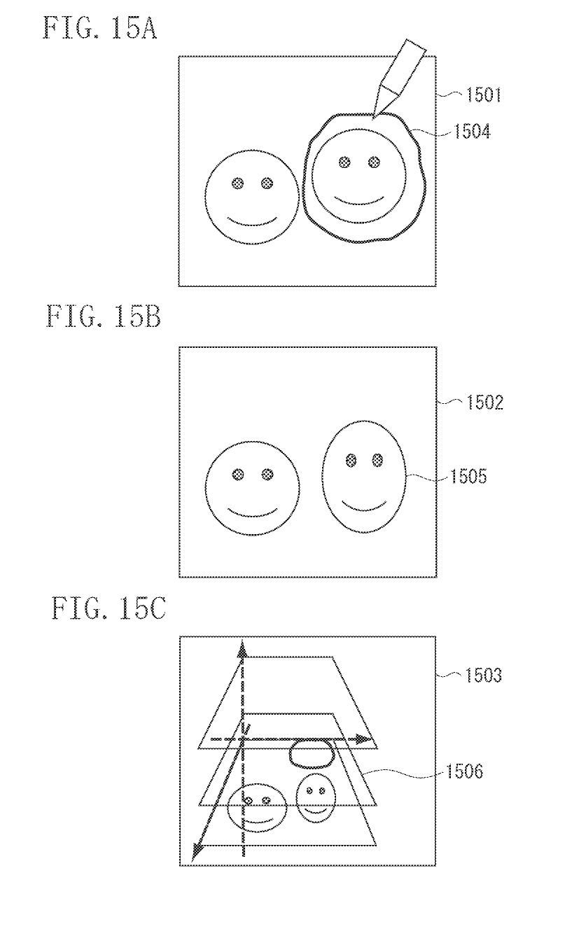

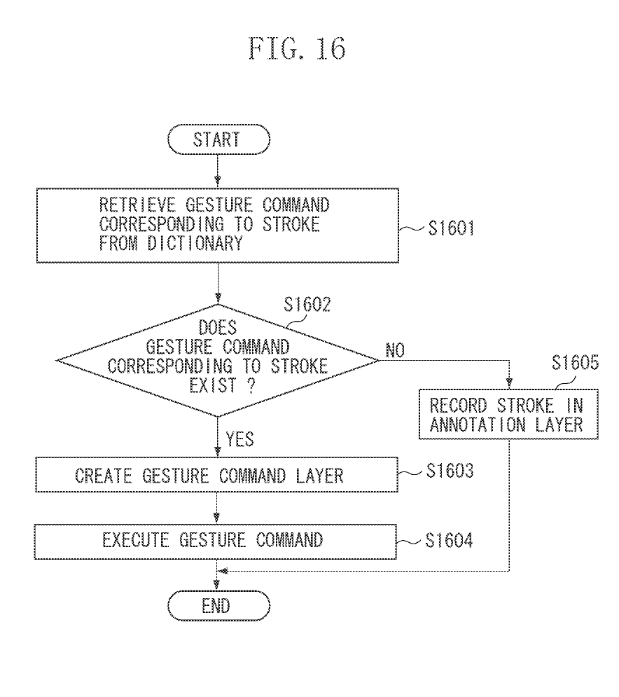

In the present exemplary embodiment, processing immediately after a stroke (object) is input is different from the one in the second to fourth exemplary embodiment. FIGS. 15A, 15B, and 15 illustrate an example of the manner how a gesture command corresponding to the input stroke is executed. On the other hand, FIG. 16 is a flowchart illustrating an example of processing of the information processing apparatus 101, when a stroke is input. For example, like a screen 1501 illustrated in FIG. 15A, when a stroke 1504 is input to surround a face of human object at right-hand side two-dimensionally displayed with a circle, the flowchart illustrated in FIG. 16 is executed. First, in step S1601, the layer editing unit 105 searches a gesture command corresponding to the input stroke from the dictionary of gesture commands (refer to FIG. 9). Next, in step S1602, the layer editing unit 105 determines whether the gesture command corresponding to the input stroke exists in the dictionary of gesture commands. If the gesture command corresponding to the stroke exists in the dictionary of the gesture commands (YES in step S1602), as a result of this determination, then the process proceeds to step S1603. If the gesture command does not exist (NO in step S1602), then the process proceeds to step S1605.

When the process proceeds to step S1603, the layer editing unit 105 creates a gesture command layer with gesture command flag set true, and causes the input stroke to belong to the gesture command layer. Next, in step S1604, the information processing apparatus 101 executes the gesture command corresponding to the stroke which has been caused to belong to the gesture command layer in step S1603. A screen 1502 illustrated in FIG. 15B indicates an example of the manner after the gesture command has been executed. A face 1505 of human object at right-hand side illustrated on a screen 1502 illustrated in FIG. 15B is deformed slimmer than a face of human object at right-hand side illustrated on the screen 1501 illustrated in FIG. 15A. The stroke belonging to the gesture command layer is made invisible at the time of two-dimensional display after the gesture command has been executed.

In this process, when the user gives an instruction to switch a view from two-dimensional display to three-dimensional display by performing a predetermined operation, the display is switched from the screen 1502 illustrated in FIG. 15B to a screen 1503 illustrated in FIG. 15C. As illustrated in FIG. 15C, a three-dimensional view displays an execution-finished gesture command layer 1506, and allows the user to confirm at one time the both of execution results of the input stroke, and the gesture command corresponding to its stroke. Returning to description of FIG. 16, in step S1602, if it is determined that the gesture command corresponding to the input stroke does not exist in the dictionary of gesture commands (NO in step S1602), then the process proceeds to step S1605. When the process proceeds to step S1605, the layer editing unit 105 causes the input stroke to belong to an annotation layer with command layer flag set false. The stroke belonging to the annotation layer is also displayed when it is two-dimensionally displayed.

In the present exemplary embodiment as described above, when a stroke corresponding to the gesture command is input, the input stroke is caused to belong to the gesture command layer with gesture command flag set true, and the gesture command corresponding to the stroke is immediately executed. Then, two-dimensional display for illustrating an execution result of the gesture command is performed. Thereafter, when a predetermined instruction is given by the user, objects belonging to each layer are displayed in the three-dimensional layered structure for each layer by switching from the two-dimensional display. Therefore, even in a case where after a gesture has been input, the gesture is immediately executed, the effect in which annotations and gesture commands which have overlaps with each other can be simply handled is obtained, in addition to the effect described in the above-described exemplary embodiments.

Next, a sixth exemplary embodiment of the present invention will be described. In the present exemplary embodiment, a case where the gesture command which once has been executed on an object is executed once again on another object will be described. Thus, the present exemplary embodiment adds the processing of executing a gesture command, which has been executed on a certain object, on another object, without having performed another input of stroke, to the above-described second to fifth exemplary embodiments. Therefore, in the descriptions of the present exemplary embodiment, the reference numerals identical to reference numerals designated to FIG. 1 to FIG. 16 are designated to the parts identical to those in the above-described first to fifth exemplary embodiments, and thus detailed descriptions thereof will not be repeated.

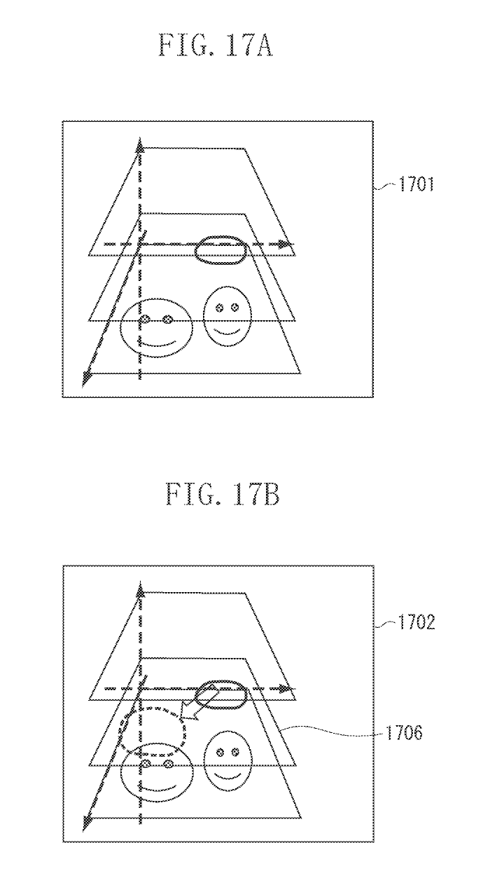

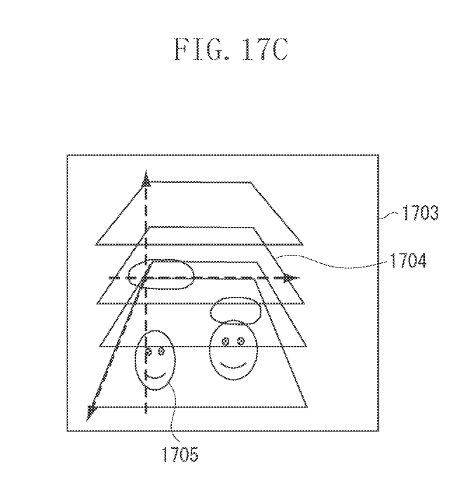

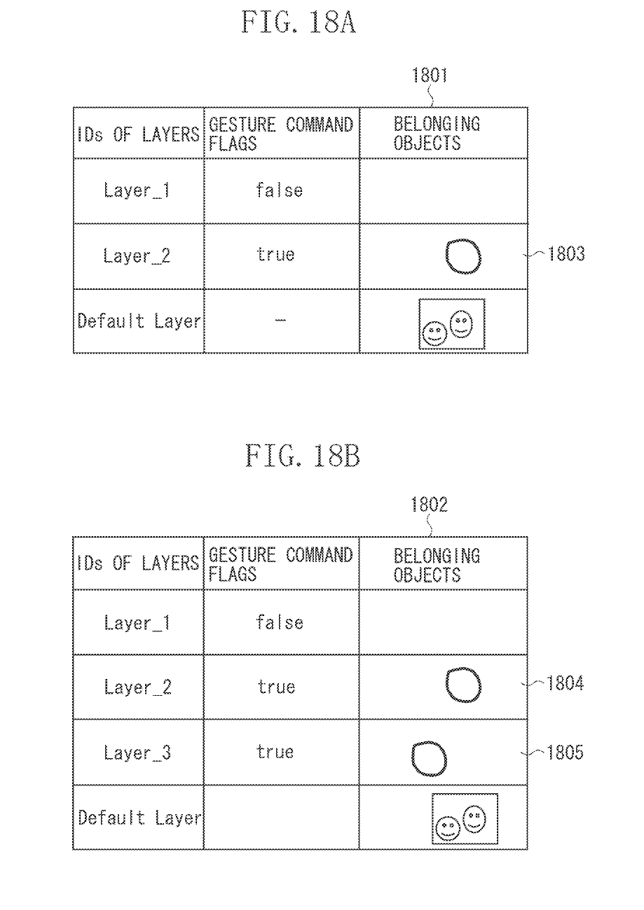

FIGS. 17A, 17B, and 17C illustrate an example of the manner how a gesture command, which has been executed on a certain object, is executed on another object, without having performed another input of stroke. FIGS. 18A and 18B illustrate conceptually an example of contents of the layer management tables. A screen 1701 illustrated in FIG. 17A illustrates three-dimensional display (the screen 1503 illustrated in FIG. 15C), described in the fifth exemplary embodiment. A layer management table 1801 illustrated in FIG. 18A is a layer management table corresponding to the screen 1701. As illustrated in a region 1803, a circular stroke is arranged in the Layer_2 with gesture command flag set true, and a face of human object at right-hand side is deformed slim, on the screen 1701.

In this process, as illustrated on a screen 1702 of FIG. 17B, the user drags and drops a circular stroke displayed on a layer 1706 of the Layer_2 on a face of human object at left-hand side. Then, the layer editing unit 105 creates a new layer in which a stroke is arranged at the same position as dropped x-coordinate and y-coordinate, and the three-dimensional layer presentation unit 107 displays the new layer (refer to a screen 1703 illustrated in FIG. 17C). A gesture command flag of the newly created layer is true. The information processing apparatus 101 executes a gesture command corresponding to the stroke belonging to the newly created layer, the instant when the gesture command flag is newly created, and deforms a face 1705 of human object at left-hand side slim.

A layer management table 1802 illustrated in FIG. 18B is a layer management table corresponding to the screen 1703. As illustrated in regions 1804 and 1805, there is created the Layer_3 to which the gesture command belongs, for making a face of human object at right-hand side slim, in addition to the Layer_2 to which the gesture command belongs, for making a face of human object at left-hand side slim.

In the present exemplary embodiment as described above, the user drags and drops a stroke displayed on the layer 1706 with gesture command flag set true. Then, aside from the layer 1706, a layer 1704 to which the stroke belongs, with gesture command flag set true is newly created. Then, processing corresponding to a stroke (gesture command) which belongs to the layer 1704 is executed on an object which is opposed to the stroke. Therefore, in addition to the effect described in the above-described exemplary embodiments, without having input the stroke twice, the effect in which reuse of the gesture command can be performed is obtained.

Next, a seventh exemplary embodiment of the present invention will be described. In the present exemplary embodiment, an application destination of a gesture command, which once has been executed on an object is changed. Thus, the present exemplary embodiment adds the processing of canceling a gesture command executed on a certain object, and executing on another object, to the above-described second to fifth exemplary embodiments. Therefore, in the descriptions of the present exemplary embodiment, the reference numeral identical to reference numerals designated to FIG. 1 to FIG. 16 are designated to the parts identical to the above-described first to fifth exemplary embodiments, and thus the detailed descriptions thereof will not be repeated.

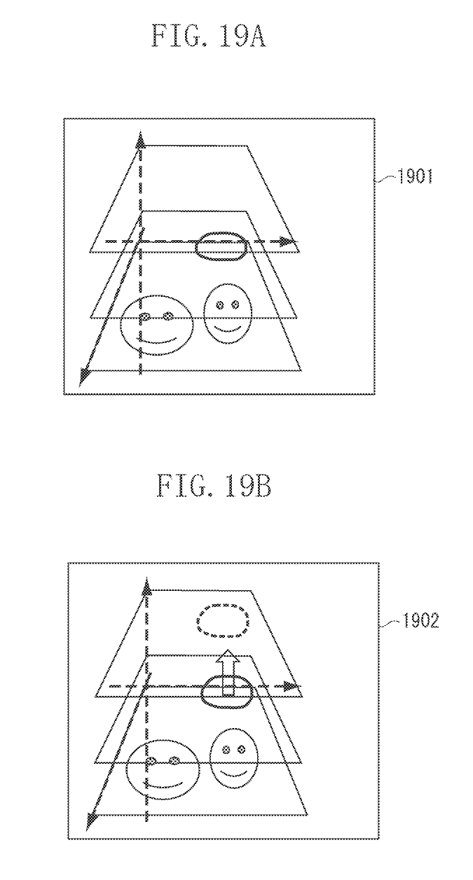

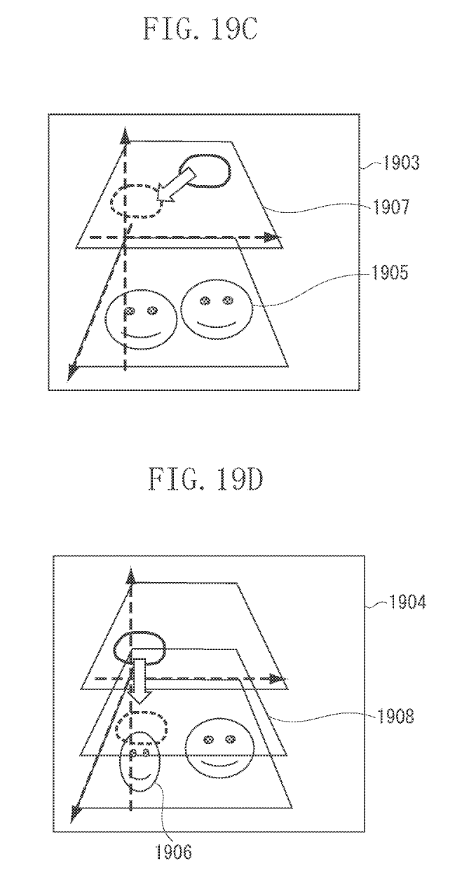

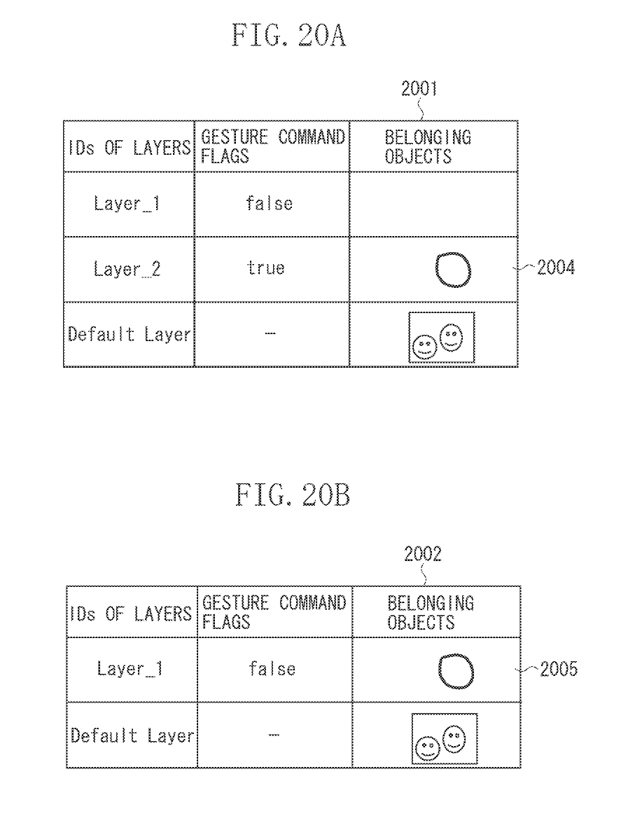

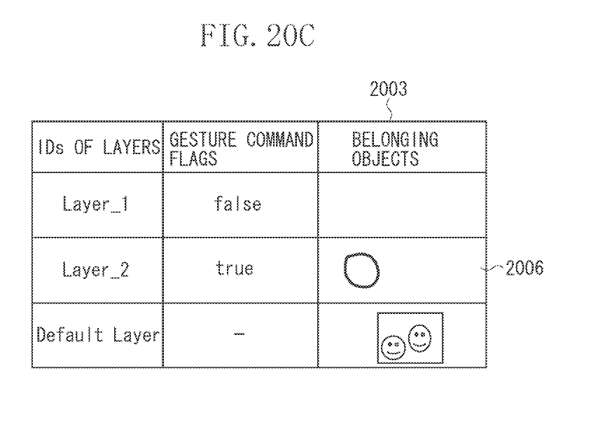

FIGS. 19A to 19D illustrate an example of the manner how a gesture command, which has been executed on a certain object, is canceled, and the gesture command is executed on another object. FIGS. 20A to 20C illustrate conceptually an example of contents of the layer management tables. A screen 1901 illustrated in FIG. 19A indicates the three-dimensional display (the screen 1503 illustrated in FIG. 15C) described in the fifth exemplary embodiment. A layer management table 2001 illustrated in FIG. 20A is a layer management table corresponding to the screen 1901. As illustrated in a region 2004, a circular stroke on the Layer_2 with gesture command flag set true is arranged, and on the screen 1904, a face of human object at right-hand side is deformed slim.

In this process, in the present exemplary embodiment, the layer editing unit 105, as illustrated in a screen 1902 of FIG. 19B, performs processing of moving a circular stroke to an annotation layer with gesture command flag set false, based on drag-and-drop operation by the user. In the present exemplary embodiment, when drag operation is input after single-clicking on the stroke, it is handled as movement processing of the stroke between layers, and when drag operation is input without having performed any operation, it is handled as movement processing on the identical layer.

A layer management table 2002 illustrated in FIG. 20B is a layer management table corresponding to the screen 1902. As illustrated in the region 2004, a stroke which belonged to the Layer_2 with gesture command flag set true, as illustrated in a region 2005, moves to the Layer_1 with gesture command flag set false, and the Layer_2 itself is deleted. At this point, like a face 1905 of human object at right-hand side in a screen 1903 illustrated in FIG. 19C, the processing of the gesture command on the face of human object at right-hand side (processing for making the face slim) is canceled, and as a result, the face of human object at right-hand side is returned to a state before it is deformed slim.

As described above, a canceling operation of executed gesture command is performed by manually moving a stroke from a layer with gesture command flag set true to a layer with gesture command flag set false. However, the canceling operation of the executed gesture command is not limited to this sort. The canceling operation of the gesture command may be performed by providing, for example, a separate button or a short-cut key in advance, and moving the stroke by inputting via these button or key.

Subsequently, like the screen 1903 illustrated in FIG. 19C, the user drags and drops a stroke on an annotation layer 1907 to move it onto a face of human object at left-hand side. In this case, editing may be added to a separate stroke so as to match an object of application destination of new gesture command (a face of human object at left-hand side in the example illustrated in FIGS. 19A, 19B, 19C, and 19D). Size or position of the stroke can be adjusted by performing enlargement or reduction, rotation or the like of the stroke, so as to match, for example, the face of human object at left-hand side. Editing operation on these strokes can be performed by providing a button on a screen in advance. By the user pressing the button to switch between editing modes, a plurality of editing operations may be performed by drag operation to the stroke same as movement.

Like a screen 1904 illustrated in FIG. 19D, the user, after having single-clicked on a stroke subjected to movement, drags and drops the stroke in a negative direction of the z-axis. And then, a layer 1908 with gesture command flag set true is created and displayed, by executing processing according to the flowchart of FIG. 11 described in the second exemplary embodiment. In the present exemplary embodiment, at the time point when a layer with gesture command flag set true is created, the gesture command is to be executed. Accordingly, the face 1906 deformed slim is displayed. The arrows illustrated in FIG. 19B to FIG. 19D are written for convenience of explanation, and are not the ones to be displayed on the screens 1902 to 1904

In the present exemplary embodiment as described above, a stroke is input, processing corresponding to a gesture command associated with the stroke is executed on the object opposed to the stroke. After that, based on drag-and-drop operation by the user, the layer is displayed in three-dimensional layered structure by causing the stroke to belong to a layer with gesture command flag set false. Further, the layer with the gesture command flag set true, to which the stroke belonged, is deleted, and processing corresponding to the gesture command is canceled. After that, a stroke displayed on a layer with the gesture command flag set false is moved on the layer, based on drag-and-drop operation by the user. Then, the stroke is caused to belong to a layer with the gesture command flag set true, and the processing corresponding to the gesture command associated with the stroke is executed, on an object which is opposed to the stroke. Therefore, in addition to the effect described in the above-described exemplary embodiments, the effect in which an application destination of gesture command which once has been input can be changed easily and surely to another object is obtained.

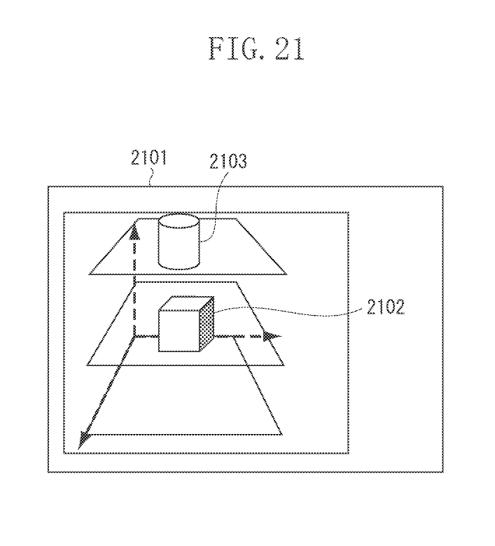

Next, an eighth exemplary embodiment of the present invention will be described. In the above-described first to seventh exemplary embodiments, although an object or a gesture command (stroke) two-dimensionally is displayed as an example, a three-dimensional object, or a three-dimensional gesture command (stroke) may be used in place of these. FIG. 21 illustrates an example of the manner how the three-dimensional object is displayed on a three-dimensionally displayed layer. Like a screen 2101 illustrated in FIG. 21, three-dimensional objects 2102 and 2103 are displayed on the three-dimensionally displayed layer, and the processing corresponding to the gesture command may be executed on the three-dimensional objects 2102 and 2103. Thus, the three-dimensional objects, and the three-dimensional gesture commands (strokes) can be handled similarly to those described in the first to seventh exemplary embodiments.

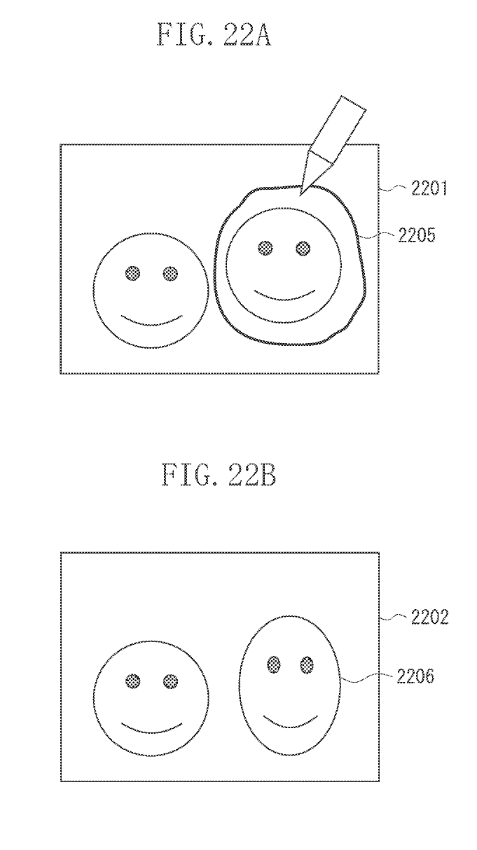

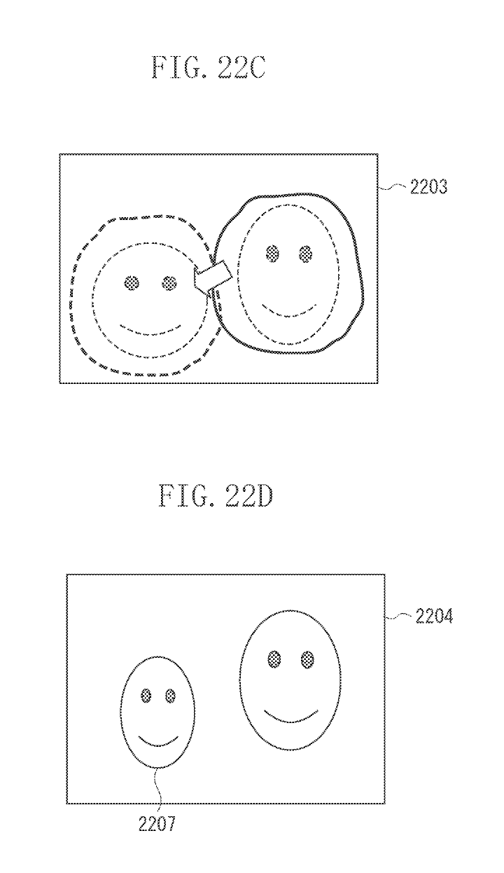

Next, a ninth exemplary embodiment of the present invention will be described. In the above-described first to eighth exemplary embodiments, as an example, a case has been described where a layer is three-dimensionally displayed. In contrast, in the present exemplary embodiment, a case where a layer is not three-dimensionally displayed but displayed only in two-dimensional manner will be described. Thus, between the present exemplary embodiment and the above-described first to eighth exemplary embodiments, the processing is mainly different in that only two-dimensional display is performed without displaying a layer in three-dimensional manner. Therefore, in the descriptions of the present exemplary embodiment, the reference numerals identical to reference numerals designated to FIG. 1 to FIG. 21 are designated to the parts identical to the above-described first to eighth exemplary embodiments, and thus detailed descriptions thereof will not be repeated. In the present exemplary embodiment, there will be described a case where a layer is not displayed three-dimensionally but only a two-dimensional display is performed in the sixth exemplary embodiment (a case where a gesture command once has been executed on an object, and is executed once again on another object). FIGS. 22A, 22B, 22C, and 22D illustrate an example of the manner how only two-dimensional display is performed without having three-dimensionally displayed a layer, and the gesture command once has been executed on an object, and is executed once again on another object. The layer management tables used in the present exemplary embodiment are the same as the ones illustrated in FIGS. 18A and 18B.

Also, in the present exemplary embodiment, an event to surround a face of human object with a circular stroke corresponds to the gesture command that deforms the face slim. Further, in the present exemplary embodiment, when a stroke is input into a gesture command layer with the gesture command flag set true, execution of processing corresponding to the gesture command associated with the stroke is performed.

In a screen 2201 illustrated in FIG. 22A, a face of human object at right-hand side is surrounded with a circular stroke 2205, and the face is deformed slim. The layer management table in this case becomes similar to the layer management table 1801 illustrated in FIG. 18A. As illustrated in the region 1803, a circular stroke belongs to the Layer_2 with the gesture command flag set true. Therefore, like a face 2206 of human object at right-hand side illustrated in a screen 2202 of FIG. 22B, the stroke 2205 becomes invisible, after the gesture command that deforms the face slim has been executed.

When the circular stroke is used once again for another object, change processing of a display layer is performed here. The change processing of the display layer is performed by the user pressing a predetermined button or the like separately provided. Further, each time the user presses the predetermined button, display layers may be switched one by one. Alternatively, change processing of the display layers may be performed by other methods.

A screen 2203 illustrated in FIG. 22C indicates that the display layer has been changed to the Layer_2. When the display layer is changed, the circular stroke which was previously invisible is displayed. In this case, a face of human object represented by dotted lines is also displayed as background. In a state where the display layer has been changed to the Layer_2, like the screen 2203 illustrated in FIG. 22C, the user drags and drops the circular stroke on an object on which the gesture command wanted to be executed once again.

Then, the layer management table becomes similar to the layer management table 1802 illustrated in FIG. 18B. A circular stroke held on the Layer_2 as it is, as illustrated in the region 1804, is newly created in the Layer_3 with the gesture command flag set true, as illustrated in the region 1805. The circular stroke is copied at a position on the Layer_3, and at the same position as x-coordinate and y-coordinate dropped on the Layer_2.

After the Layer_3 has been created, when the user performs operation to restore the display layer, a face 2207 of human object at left-hand side is deformed slim, like a screen 2204 illustrated in FIG. 22D. In the present exemplary embodiment as described above, the user designates a layer of the display target, and an object of the designated layer is displayed to remain two-dimensional display. Therefore, the effect described in the sixth exemplary embodiment is obtained, without performing three-dimensional display of the layer.

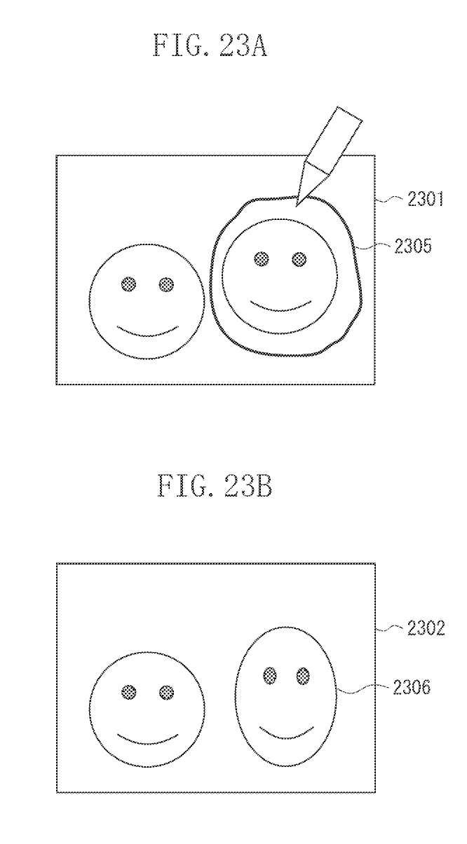

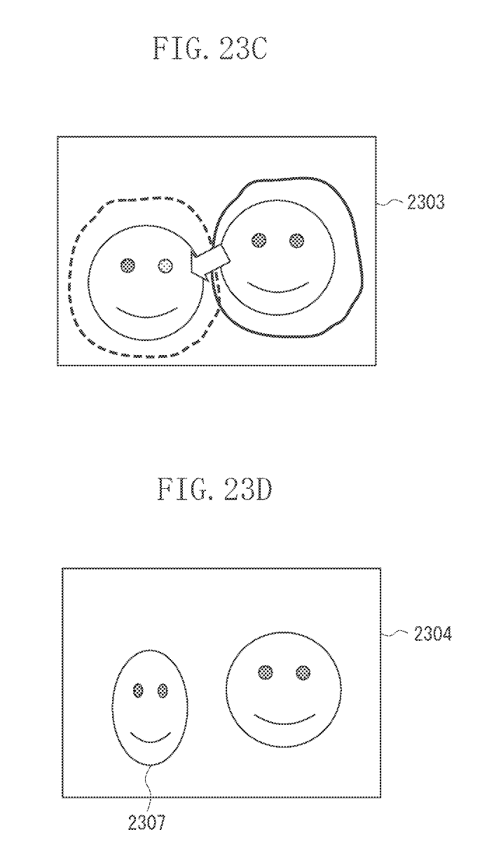

Next, a tenth exemplary embodiment of the present invention will be described. In the above-described ninth exemplary embodiment, on the premise of the sixth exemplary embodiment, a case has been described where only two-dimensional display is performed without displaying a layer in a three-dimensional manner as an example. In contrast, in the present exemplary embodiment, in the seventh exemplary embodiment (in a case where application destination of the gesture command once executed on an object is changed), a case where only two-dimensional display is performed without displaying a layer in the three-dimensional manner will be described. FIGS. 23A, 23B, 23C, and 23D illustrate an example of the manner how only two-dimensional display is performed, and application destination of the gesture command once executed on an object is changed, without displaying a layer in the three-dimensional manner. The layer management tables used in the present exemplary embodiment are the same as those illustrated in FIGS. 20A, 20B, and 20C.

Also, in the present exemplary embodiment, an event to surround a face of human object with a circular stroke corresponds to the gesture command which deforms a face slim. Further, in the present exemplary embodiment, when a stroke is input into the gesture command layer with the gesture command flag set true, execution of processing corresponding to the gesture command associated with the stroke is to be performed.

In a screen 2301 illustrated in FIG. 23A, a face of human object at right-hand side is surrounded with a circular stroke 2305, and the face is deformed slim. The layer management table in this case becomes similar to the layer management table 2001 illustrated in FIG. 20A. As illustrated in the region 2004, a circular stroke belongs to the Layer_2 with the gesture command flag set true. Therefore, like a face 2306 of human object at right-hand side illustrated in a screen 2302 of FIG. 23B, the stroke 2305 becomes invisible, after the gesture command that deforms the face slim has been executed.

When the gesture command that deforms a face slim is applied to another object, application destination change processing is performed here. The application destination change processing is executed by UNDO processing, and drag-and-drop operation to a new application destination. The UNDO processing after the gesture command has been executed is to move a stroke from a layer with the gesture command flag set true to a layer with the gesture command flag set false. As a result, when the UNDO processing is executed in a state of the screen 2302 illustrated in FIG. 23B, like a screen 2303 illustrated in FIG. 23C, the deformation processing of slim is canceled, and the circular stroke is displayed as an annotation.

The layer management table in this case becomes similar to the layer management table 2002 illustrated in FIG. 20B. The Layer_2 from which the stroke has disappeared is deleted, as illustrated in the region 2005, and the circular stroke moves to the Layer_1 with the gesture command flag set false.

When the execution of the UNDO processing is terminated, and the user drags and drops a stroke in an arrow direction on the screen 2303 illustrated in FIG. 23C, the stroke moves to an object as the execution target of the gesture command. In this process, when the user gives instruction to execute the gesture command, like a screen 2304 illustrated in FIG. 23D, a face 2307 of human object at left-hand side is deformed slim. The layer management table in this case becomes similar to a layer management table 2003 illustrated in FIG. 20C. The gesture command may be executed by pressing a separately prepared button, or may be executed by preparing gesture commands in advance for starting the gesture command corresponding to a stroke, and inputting the gesture command. Alternatively, the gesture command may be executed by other methods.

In the present exemplary embodiment as described above, after a gesture command has been executed, a stroke associated with the gesture command moves from a layer with gesture command flag set true to a layer with gesture command flag set false. Accordingly, the stroke returns to a two-dimensional display state as it was before the gesture command is executed. After that, when the user drags and drops the stroke in a direction of another object, the processing corresponding to the gesture command associated with the stroke is executed on the object. At this time, a layer with gesture command flag set true is created, and dragged and dropped stroke is caused to belong to the created layer. Therefore, the effect described in the seventh exemplary embodiment is obtained without performing three-dimensional display of the layer.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention

The above-described exemplary embodiments each only illustrate an example of embodiments in implementing the present invention, and technical scope of the present invention should not be interpreted in limited manner In other words, the present invention can be implemented in various forms without deviating from the technical ideas, or the main features.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-287819 filed Dec. 18, 2009, which is hereby incorporated by reference herein in its entirety.

What is claimed is:

1. An information processing apparatus comprising:
a holding unit configured to hold information that associates objects constituting images, with layers to which the objects belong;
a display control unit configured to display hierarchical relationship of the layers and the objects belonging to respective layers on a display unit, based on information held in the holding unit; and
a control unit configured to create a new layer when an object of interest out of displayed objects is moved by distance equal to or more than a predetermined distance from a layer to which the object of interest belongs, and cause the object of interest to belong to the created layer.

2. The information processing apparatus according to claim 1, wherein when the object of interest is moved from a layer to which the object of interest belongs by distance equal to or more than a predetermined distance, the control unit creates the new layer, at a position apart from a layer to which the object of interest belongs by a predetermined distance, and causes the object of interest to belong to the created layer.

3. The information processing apparatus according to claim 1, wherein the display control unit sorts the objects for each hierarchical layer of layers to which the objects belong, and displays the objects in a three-dimensional hierarchical structure.

4. A control method of an information processing apparatus for causing an object to belong to a predetermined layer, the method comprising:
holding information that associates objects constituting images, with layers to which the objects belong;
displaying hierarchical relationship of the layers and the objects belonging to respective layers on a display unit, based on the held information; and
creating a new layer, and causing the object of interest to belong to created layer when an object of interest out of the objects displayed is moved by distance equal to or more than a predetermined distance from a layer to which the object of interest belongs.

5. A computer-readable storage medium that stores a computer program for causing a computer to load and execute a computer program thereby causing the computer to function as an information processing apparatus comprising:
a holding unit configured to hold information that associates objects constituting images, with layers to which the objects belong;
a display control unit configured to display hierarchical relationship of the layers and the objects belonging to respective layers on a display unit, based on information held in the holding unit; and
a control unit configured to create a new layer and cause the object of interest to belong to the created layer when an object of interest out of displayed objects is moved by distance equal to or more than a predetermined distance from a layer to which the object of interest belongs.
